(19) United States
(12) Patent Application Publication
(10) Pub. No.: US 2002/0076499 A1
(43) Pub. Date: Jun. 20, 2002

(54) Coating device and coating method

(75) Inventors: Shin Kanke, Shizuoka-ken (JP); Satoru Matsumoto, Shizuoka-ken (JP); Go Nishino, Shizuoka-ken (JP); Shinichi Funabashi, Shizuoka-ken (JP)

Correspondence Address: SUGHRUE MION, ZINN, MACPEAK & SEAS, PLLC, Suite 800, 2100 Pennsylvania Avenue, NW, Washington, DC, 20037-7060, US

(73) Assignee: FUJI PHOTO FILM CO., LTD.

(21) Appl. No.: 10/024,548

(22) Filed: Dec. 21, 2001

(30) Foreign Application Priority Data
Dec. 16, 2000 (JP) 2000-395955

(51) Int. Cl. B05D 1/28

(52) U.S. Cl. 427/355; 427/428; 118/217; 118/244

(57) ABSTRACT

A coating device and a coating method capable of performing stable coating without causing defects such as a discontinuous coating film even if a web is run at a high speed. The coating device includes: a bar which is in contact with the web and can rotate about an axis; a liquid supply passage which is arranged adjacent to the bar at an upstream side from the bar and supplies a coating liquid to be applied to the web between the web and the bar to form a coating liquid reservoir when the web is being run; and an air-intrusion preventing unit which is arranged at an upstream side from the coating liquid reservoir and produces a liquid flow along a web surface to prevent an accompanying air film produced on the web surface from intruding into the coating reservoir when the web is being run.

### BACKGROUND OF THE INVENTION

1. Field of the Invention

The present invention relates to a coating device and a coating method and, in particular, to a coating device and a coating method capable of stably coating a web with a coating liquid by the use of a bar coater, even when the web is run at a high speed.

2. Description of the Related Art

A planographic plate is usually manufactured as follows: at least one surface of a pure aluminum or aluminum alloy web is roughened, and an anodic oxidation film is formed thereon as necessary, to form a support web; then a photosensitive layer-forming liquid or a thermosensitive layer-forming liquid is applied to the roughened surface of the support web and is dried to form a photosensitive or thermosensitive printing surface.

When a belt-like web such as this support web is coated with a coating liquid such as the photosensitive layer-forming liquid or the thermosensitive layer-forming liquid, a bar coater is usually used.

As the bar coater, a coater has been usually used that has: a bar which is in contact with the bottom surface of the continuously running web and rotates in the same direction or in a direction opposite to a running direction of the web; and a coating part which discharges a coating liquid at an upstream side with respect to the running direction of the web (hereinafter referred to simply as “upstream side”) to form a coating liquid reservoir to coat the bottom surface of the web with the coating liquid.

As the bar coater described above, generally used have been an SLB type bar coater (Japanese Utility Model Application No. 63-126213), which has a first dam plate provided adjacent to the bar on the upstream side of the bar and formed such that a top end portion is gradually thinner toward a downstream side with respect to the running direction of the web (hereinafter referred to simply as “downstream side”) and such that the top end portion is bent toward the bar and has a flat surface of 0.1 mm to 1 mm in length at the top, and a PBS type bar coater (Japanese Patent Application Publication (JP-B) No. 58-004589) having the first dam plate which is formed such that the top end portion is gradually thinner toward the downstream side, the bar, and a second dam plate provided at the downstream side of the bar.

However, when the running speed of the support web is increased, air running with the support web, that is, an accompanying air film which accompanies the web, is formed on the surface of the support web.

In either of the SLB type bar coater and the PBS type bar coater, when this accompanying air film is formed at the surface of the support web, the accompanying air film presents a problem that the accompanying air film is brought into a coating liquid reservoir at the coating part by the support web, causes defects such as discontinuity of a coating film of the coating liquid formed on the surface of the support web, and precludes stable coating of the coating liquid.

### SUMMARY OF THE INVENTION

An object of the present invention is to provide a coating device and a coating method capable of performing a stable coating without causing a defect such as a discontinuous coating film even when a web such as the above-described support web is run at a high speed fast enough to form an accompanying air film on the surface of the web.

In order to accomplish the above object, according to one aspect of the present invention, there is provided a device for coating a web with coating liquid while the web is being conveyed along a path of travel, the device including: a bar disposed along the path of travel and contacting the web as the web is conveyed, the bar being rotatable about an axis; a liquid supply passage including an opening in the vicinity of the bar, upstream of the bar with respect to a conveyance direction of the web, through which coating liquid is supplied between the web and the bar to form a coating liquid reservoir; and an air-intrusion preventing structure which causes fluid to flow along a surface of the web upstream of the coating liquid reservoir with respect to the web conveyance direction, and prevents an air film generated at the surface of the web from intruding between the bar and the web.

According to another aspect, there is provided a method for coating a web, the method including the steps of: conveying the web while in contact with a bar; supplying coating liquid to a coating region between the bar and the web; and preventing an air film from intruding into the coating region by causing fluid to flow along a surface to be coated of the web.

### BRIEF DESCRIPTION OF THE DRAWINGS

FIG. 1 is a perspective view showing a schematic configuration of an example of a coating device in accordance with the present invention.

FIG. 2 is a cross-sectional view, cut along a vertical plane along a running direction of a web, of the coating device shown in FIG. 1.

FIG. 3 is a cross-sectional view showing detailed flow of a photosensitive layer-forming liquid between a support web, a bar, a bar support member and a coating liquid flow-forming surface in the coating device shown in FIG. 1.

FIG. 4 is a cross-sectional view showing a schematic configuration, cut along a vertical plane along a running direction of a web, of another example of a coating device in accordance with the present invention.

FIG. 5 is a cross-sectional view showing a schematic configuration, cut along a vertical plane along the running direction of a web, of still another example of a coating device in accordance with the present invention.

FIG. 6 is a perspective view showing a schematic configuration of an example of a coating device in accordance with the present invention, this example having a coating liquid supply flow passage in which through-holes formed in a vertical direction are arranged in a line.

FIG. 7 is a cross-sectional view, cut along a vertical plane along the running direction of a web, of the coating device shown in FIG. 6.

FIG. 8 is a cross-sectional view, cut along a vertical plane along the running direction of a web, of an example provided with a continuous projection along a direction of length on an upstream-side end portion of a coating liquid flow-forming surface of a dam plate in a coating device in accordance with a first embodiment.

FIG. 9 is a cross-sectional view, cut along a vertical plane along the running direction of a web, of an example provided with an auxiliary coating liquid supply flow passage in the center of a dam plate 6 in the coating device in accordance with the first embodiment.

FIG. 10 is a cross-sectional view showing a schematic configuration of an HSB type bar coater used in a Comparative Example 1.

FIG. 11 is a cross-sectional view showing a schematic configuration of an SLB type bar coater used in a Comparative Example 2.

FIG. 12 is a cross-sectional view showing a schematic configuration of a PBS type bar coater used in a Comparative Example 3.

### DESCRIPTION OF THE PREFERRED EMBODIMENTS

1. First Embodiment

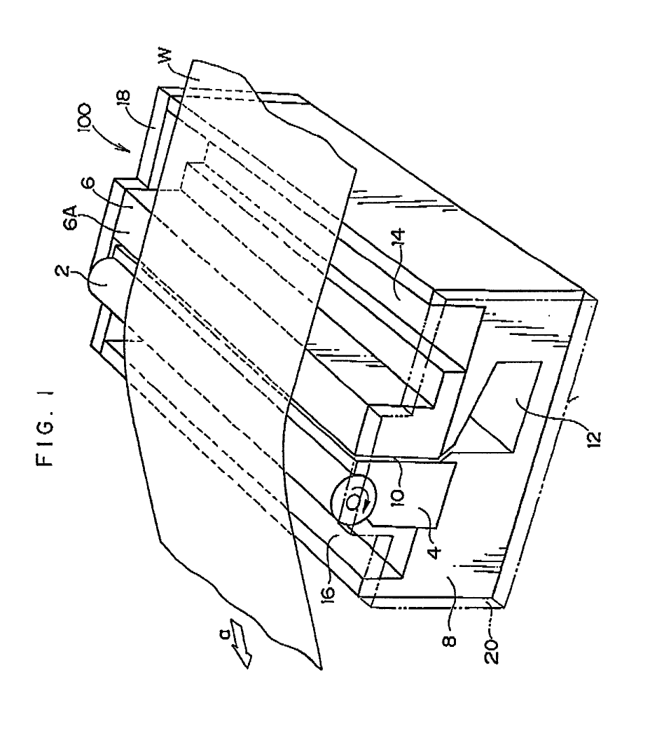

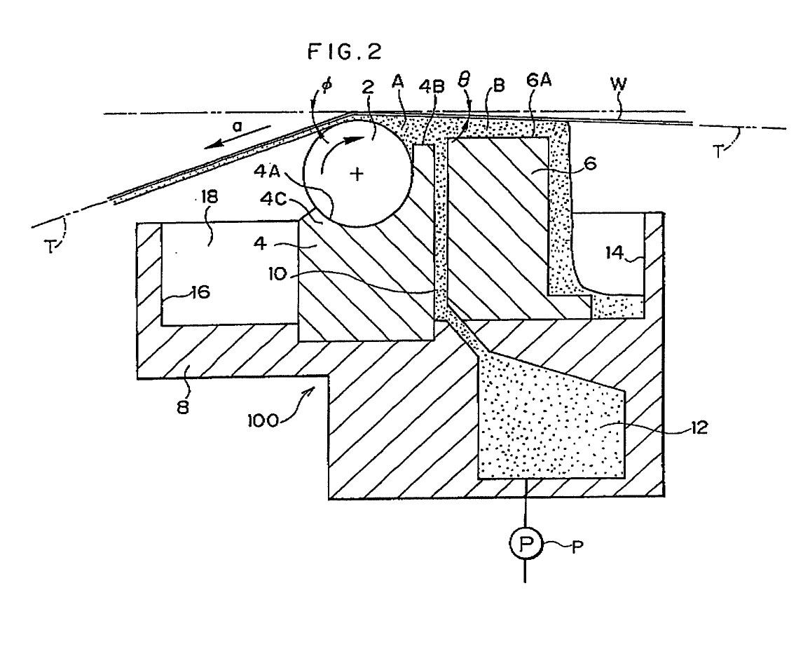

The schematic configuration of one example of a coating device in accordance with the present invention is shown in FIG. 1 and FIG. 2.

As shown in FIG. 1 and FIG. 2, a bar coater 100 in accordance with a first embodiment has a bar 2 which is ill contact with the bottom surface of a support web W being conveyed along a path of travel in a running direction (a) and which rotates about an axis, a bar support member 4 which is provided along a direction of length of the bar 2 and supports the bar 2 from a bottom side, a dam plate 6 which is provided parallel to the bar support member 4 at an upstream side from the bar support member 4 and has a coating liquid flow-forming surface (fluid flow-forming surface) formed as a flat plane at a top surface thereof, and a basic 8 to which the bar support member 4 and the dam plate 6 are fixed.

The rotational direction of the bar 2 is opposite to the conveyance direction (a) in which the support web W runs (hereinafter simply referred to as “running direction (a)”), that is, a clockwise direction in FIG. 1 and FIG. 2. The bar 2 rotates at a rotational speed such that a circumferential speed is 1% or less of the running speed of the support web W. The rotational direction of the bar 2 may, however, be in the same direction as the running direction (a).

The surface of the bar 2 may be finished smoothly, or may be provided with grooves made at predetermined intervals in the circumferential direction, or further may be densely wound with a wire. It is preferable that the diameter of a wire wound around the bar 2 is from 0.07 mm to 1 mm, particularly preferably from 0.07 mm to 0.4 mm. Here, in a bar provided with the grooves or wound with a wire, by decreasing the depth of the grooves or the size of the wire, a coating thickness of a photosensitive layer-forming liquid can be made thin, and by increasing the depth of the grooves or the size of the wire, the coating thickness of the photosensitive layer-forming liquid can be made thick.

It is preferable that the bar 2 has a diameter ranging from 6 mm to 25 mm, because of ease of fabrication and because the coating film of the photosensitive layer-forming liquid formed on the support web W is then unlikely to produce vertical stripes.

Further, the bar 2 is usually longer than the width of the support web W, but may be as long as the width of the support web W.

Since the support web is usually in contact with the bar 2 in a state where tension is applied thereto, as shown in FIG. 1 and FIG. 2, the web is bent downward with a portion in contact with the bar 2 at a center, in other words, bent into a shape like a circumflex accent. It is preferable that an angle θ formed between a portion of the support web W at the upstream side from the bar 2 and the horizontal is from 0° to 5°, particularly, from 0° to 3°. Further, It is preferable that an angle Φ formed between a portion of the support web W at the downstream side from the bar 2 and the horizontal is from 3° to 18°, particularly, from 5° to 10°.

The bar support member 4 is a substantially plate-shaped member, and has a depressed groove 4A having an inside wall surface formed like a letter J in cross section. The bar 2 is rotatably supported from the bottom side thereof by the depressed groove 4A.

A top surface 4B of the bar support member 4 is formed such that it is disposed at the upstream side of the depressed groove 4A and is lower than a running surface T of the support web W (see FIG. 2). An upstream-side wall surface of the bar support member 4, that is, a wall surface opposing the dam plate 6, is formed in a vertical plane. A downstream-side wall 4C positioned at the downstream side of the depressed groove 4A in the bar support member 4 is lower than the top surface 4B and has a top surface formed in a shape slanting downward along the running direction (a).

The dam plate 6 is a plate-shaped member extending along the vertical plane and bent at a right angle toward the upstream side at a bottom end portion thereof, and is formed in the shape of a litter L. in overall cross section. The dam plate 6 is fixed to the base 8 at the bottom end portion. On the top surface of the dam plate 6 is formed a coating liquid flow-forming surface 6A, which is a flat end portion. The coating liquid flow-forming surface 6A is a horizontal plane in the bar coater 100, as shown in FIG. 1 and FIG. 2, but is not limited to the horizontal plane and may be a plane slanted upward in the direction opposite to the running direction (a), that is, toward the upstream side, or a cylindrical surface which is upwardly convex.

The dam plate 6 is formed such that the coating liquid flow-forming surface 6A is at a position lower than the running surface T of the support web W. Thus, when the photosensitive layer-forming liquid is applied to the support web W, a coating liquid flow-forming flow passage B is formed between the bottom surface of the support web W and the coating liquid flow-forming surface 6.

A width (thickness) of the coating liquid flow-forming surface 6A in the direction along the running direction (a), in other words, the length of the coating liquid flow-forming flow passage B in the direction along the running direction (a), is preferably larger than 0.1 mm and at most 20 mm, and is particularly preferably in a range from 3 mm to 10 mm.

The dam plate 6 is formed such that a thickness of the coating liquid flow-forming flow passage B, that is, a gap between the support web W and the coating liquid flow-forming surface 6A, is in a range from 0.25 mm to 2 mm.

The support web W, as described above, runs in the state where it is bent in the shape like a circumflex accent with o portion in contact with the bar 2 at a center of this shape, so the coating liquid flow-forming surface 6A is formed in the horizontal plane, as described above, but the coating liquid flow-forming flow passage B is reduced in thickness along the direction opposite to the running direction (a).

As shown in FIG. 1 and FIG. 2, in the bar coater 100, the coating liquid flow-forming surface 6A is higher than the top end surface of the upstream side wall 4B of the bar support member 4. The difference in height therebetween is, for example, 0.5 mm, but may be larger or smaller than 0.5 mm. However, from the viewpoint of preventing a flow of the photosensitive layer-forming liquid toward the outside along the direction of width of the support web W from being produced and preventing the photosensitive layer-forming liquid from being thus made nonuniform between the bar 2 and the support web W, it is preferable that this difference in height is not more than 1 mm. Further, the coating liquid flow-forming surface 6A may be as high as the top end surface of the upstream side wall 4B and may be lower than the top end surface of the upstream side wall 4B. However, even if the coating liquid flow-forming surface 6A is lower than the top end surface of the upstream side wall 4B, it is preferable that the difference in height is not more than 1 mm.

A wall surface on the downstream side of the wall member 6, that is, the wall surface at the side opposing the bar support member 4 is preferably formed in a vertical plane parallel to the wall surface on the upstream side of the upstream side wall 4B of the bar support member 4, but is not limited to this.

The wall surface on the upstream side of the upstream side wall 4B of the bar support member 4 and the wall surface on the downstream side of the dam plate 6 form a slit-like coating liquid supply flow passage 10 (a liquid supply passage of the present invention). The two surfaces forming the coating liquid supply flow passage 10 are vertical planes which are parallel to each other, so the coating liquid supply flow passage 10 also extends along the vertical plane parallel to the bar 2. It is preferable that the length along the running direction (a) of the coating liquid supply flow passage 10 is not more than 2 mm, and is particularly from 0.2 mm to 0.8 mm.

The coating liquid supply flow passage 10 communicates at a bottom end thereof with a storage chamber 12 formed in the base 8 to temporarily store the coating liquid. The coating liquid supply flow passage 10 has a function of discharging the photosensitive layer-forming liquid toward the support web W to form a coating liquid reservoir A between the support web W, the bar 2, and the bar support member 4 when the support web W is running. The bar support member 4, the dam plate 6, and the coating liquid supply flow passage 10 form a coating part of a coating device in accordance with the present invention. Further, the dam plate 6 corresponds to a pressure generating part in the coating device in accordance with the present invention.

The coating liquid temporary storage chamber 12 is connected to a discharge side of a coating liquid pump P for supplying the photosensitive layer-forming liquid from a storage tank (not shown) of the photosensitive layer-forming liquid, and has a function of temporarily storing the photosensitive layer-forming liquid supplied from the coating liquid pump P and reducing variations in flow of the photosensitive layer-forming liquid supplied through the coating liquid supply flow passage 10 when discharge amounts of the coating liquid pump P vary.

An overflow liquid reservoir 14 for receiving coating liquid which flows between the coating liquid flow-forming surface 6A and the bottom surface of the support web W, and an overflow liquid reservoir 16 for receiving coating liquid which is not attached to the support web W but overflows to the downstream side are formed in the base 8 on the upstream side of the dam plate 6 and on the downstream side of the bar support member 4, respectively.

Further, the overflow reservoirs 14 and 16 are preferably connected to the storage tank mentioned above via a coating liquid return pipe (not shown) for returning the received coating liquid.

As shown in FIG. 1 and FIG. 2, at the two end sides of the base 8 are fixed side plates 18 and 20. The side plates 18, 20 form side walls of the overflow liquid reservoirs 14 and 16, the coating liquid supply flow passage 10 and the coating liquid temporary storage chamber 12.

Operation of the bar coater 100 will hereinafter be described.

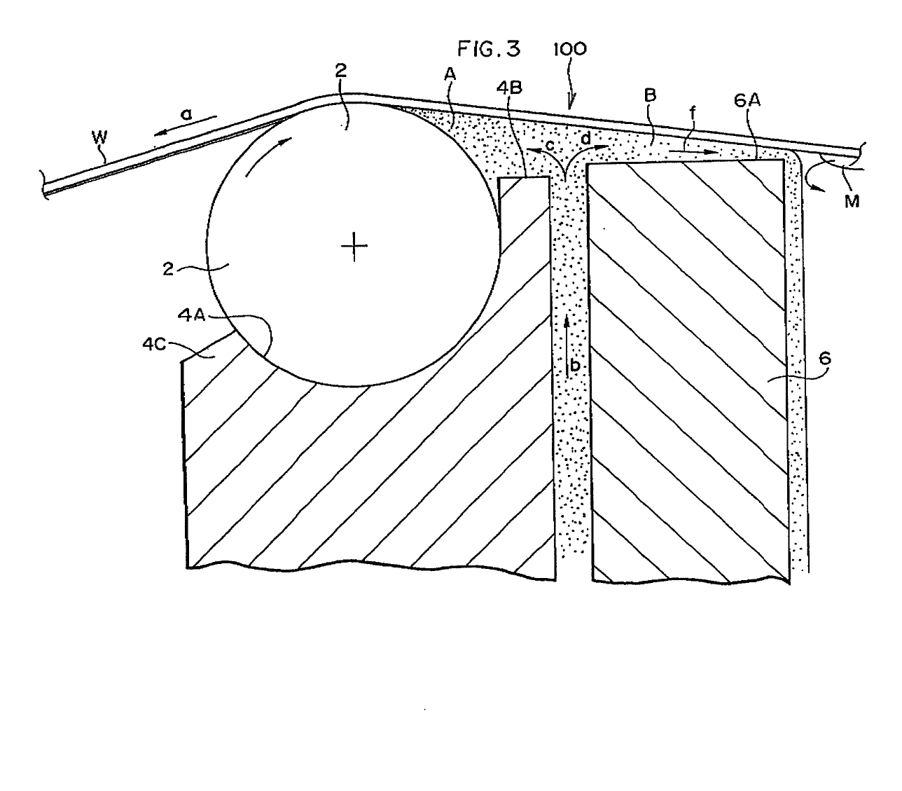

Flow of the photosensitive layer-forming liquid at the support web W, the bar 2, the bar support member 4 and the coating liquid forming surface 6A is shown in detail in FIG. 3.

The support web W is run continuously at a constant speed over the bar coater 100 in such a way that a surface on which a anodic oxidation film is formed is a bottom surface, and the bar 2 is rotated at a speed of 5 rpm in the direction opposite to the running direction (a) as viewed from the running surface T, that is, in the clockwise direction as shown by an arrow in FIG. 1 to FIG. 3.

When the photosensitive layer-forming liquid is discharged from the coating liquid pump P, the photosensitive layer-forming liquid is stored first in the coating liquid temporary storage chamber 12. When the coating liquid temporary storage chamber 12 is filled with the photosensitive layer-forming liquid, the photosensitive layer-forming liquid moves up into the coating liquid supply flow passage 10, as shown by an arrow (b) in FIG. 3, and most reaches the coating liquid reservoir A, as shown by an arrow (c), is applied to the surface on the side of the support web W at which the anodic oxidation film is formed and is moved therewith along the running direction (a). When the support web W passes over the bar 2, the photosensitive layer-forming liquid attached to the support web W is scraped off by the bar 2 so as to form a coating layer having a predetermined thickness.

Meanwhile, the remainder of the photosensitive layer-forming liquid that has moved up through the coating liquid supply flow passage 10, as shown by an arrow (d) in FIG. 3, flows into the coating liquid flow-forming flow passage B and forms a coating liquid flow (f) in the direction opposite to the running direction (a).

Since a dynamic pressure is generated in the direction opposite to the running direction (a) by the coating liquid flow (f), as shown in FIG. 3, the accompanying air film M, which is brought near to the bar coater 100 along the running direction (a) with the support web W, is pushed out to the upstream side at an inlet of the coating liquid flow-forming flow passage B.

This prevents the accompanying air film M from being brought into the coating liquid reservoir A.

Here, a discharge amount of the pump P necessary for generating the coating liquid flow (f) in the coating liquid flow-forming flow passage B can be determined in the following manner.

Assuming that the coating liquid flow (f) is not present, the coating liquid is thought to flow in the coating liquid flow-forming flow passage B along the running direction (a) at a speed of flow (u) corresponding to a running speed V of the support web W.

The above-described speed of flow (u) can be approximated, for example, from experimental data and the like, by the following expression:

u=((0.6145×60²×V²)−(10.681×60×V)+35.179)×(10⁻⁶/t)×Wd (1)

Where Wd designates the width of the support web W and t designates the average thickness of the coating liquid flow-forming flow passage B.

Then, dynamic pressure Pᵤ (kg/cm²) of the flow having the speed of flow (u) is given by the following expression:

Pᵤ=ρ×u²/2

Where ρ designates the specific gravity of the coating liquid.

Here, in order to surely prevent the accompanying air film from being brought into the coating liquid reservoir A, it is preferable that the coating liquid flow (f) in the coating liquid flow-forming flow passage B has a speed of flow (v) sufficient to generate a dynamic pressure of 0.5 kg/cm² or more in the direction opposite to the running direction (a).

The speed of flow can be determined by the following expression

Pᵤ+0.5 (kg/cm²)=(ρ×u²+0.5)/2 =ρ×v²/2

A pump flow F necessary for producing the speed of flow (u) in the coating liquid flow-forming flow passage B is given by the following expression

F=V×t×Wd

Therefore, in the bar coater 100, in order to generate the above-described coating liquid flow (f), it is recommended that a discharge flow of the pump P be larger than a discharge flow of a pump in a conventional SLB type bar coater by the pump flow F.

In the bar coater 100, even if the support web W is run at a high speed, the accompanying air film at the surface of the support web W is not brought into the coating liquid reservoir A, and thus the photosensitive layer-forming liquid can be stably applied. Consequently, this can remarkably increase production efficiency of planographic plates, and drastically decrease the incidence of defective products.

Further, the bar coater 100 can be constituted simply by replacing a first dam plate in a conventional SLB type bar coater with the dam plate 6 of the present embodiment. Hence, the present embodiment has a feature of eliminating any need for drastically modifying the conventional coater.

2. Second Embodiment

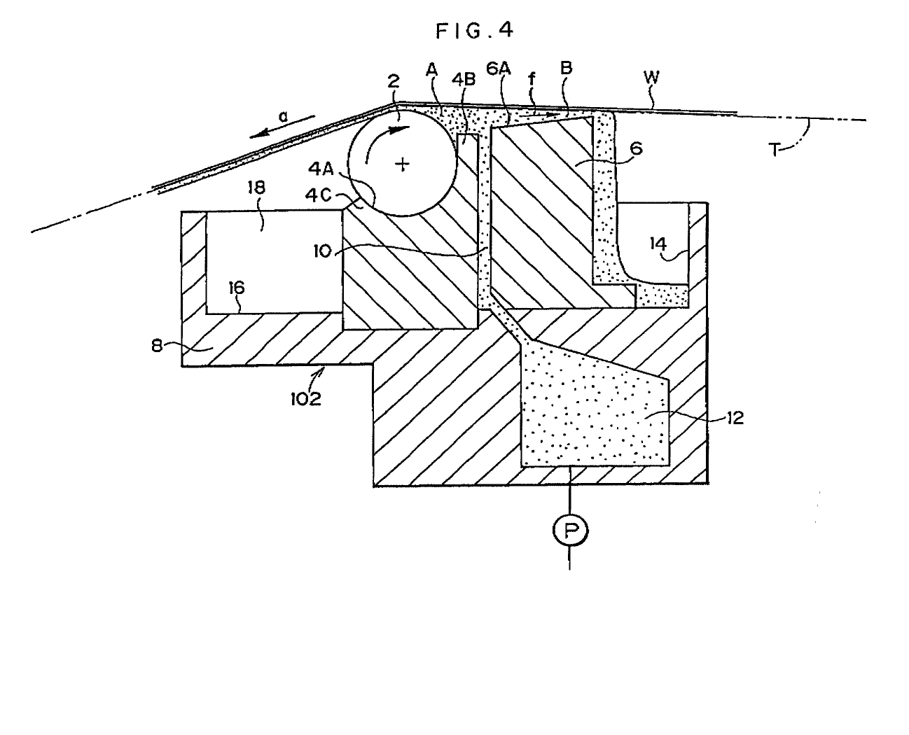

A schematic configuration of another embodiment of the coating device in accordance with the present invention is shown in FIG. 4. In FIG. 4, reference characters the same as in FIG. 1 to FIG. 3 denote the same elements as the elements denoted thereby in FIG. 1 to FIG. 3, unless otherwise noted.

As shown in FIG. 4, in a bar coater 102 in accordance with a second embodiment, the coating liquid flow-forming surface 6A is formed in the shape of a surface slanted upward toward the upstream side.

Thus, the coating liquid flow-forming flow passage B of the bar coater 102 generates a large dynamic pressure even if the speed of flow of the coating liquid flow (f) is slow, because a degree of reduction in the thickness is larger than in the bar coater 100.

Except for the above-described point, the bar coater 102 has the same structure as the bar coater 100.

Therefore, in addition to the same features as the bar coater 100, the bar coater 102 has a feature of effectively preventing the accompanying air from being brought into the coating liquid reservoir A even if the amount of coating liquid being supplied from the pump P is small.

3. Third Embodiment

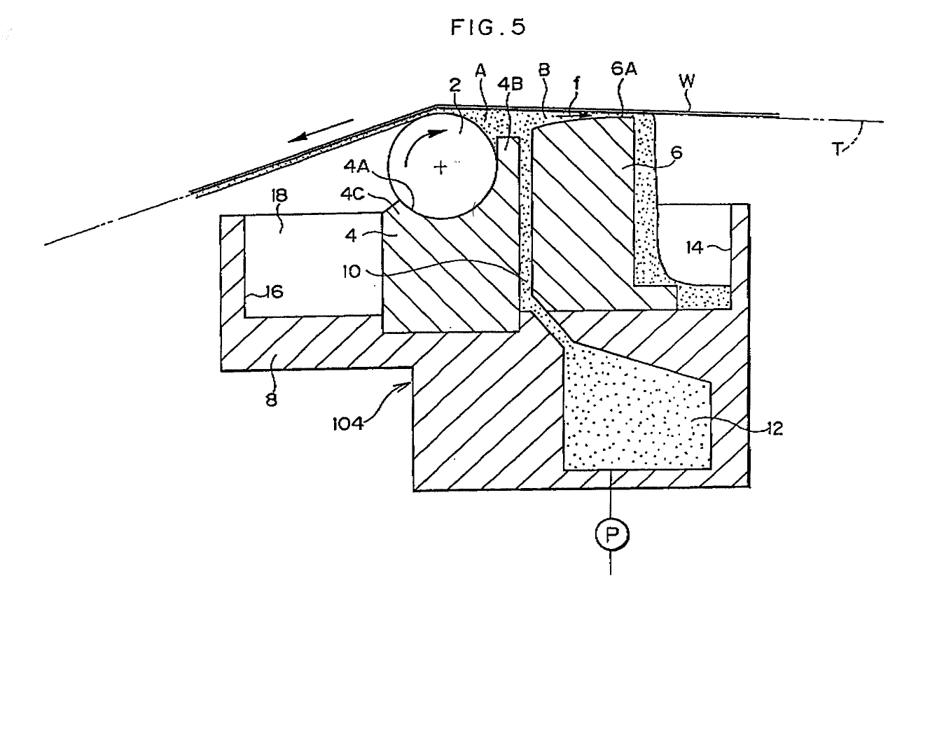

A schematic configuration of still another embodiment of the coating device in accordance with the present invention is shown in FIG. 5. In FIG. 5, reference characters the same as in FIG. 1 to FIG. 3 denote the same elements as the elements denoted thereby in FIG. 1 to FIG. 3, unless otherwise noted.

As shown in FIG. 5, in a bar coater 104 in accordance with a third embodiment, the coating liquid flow-forming surface 6A is formed in the shape of a cylindrical surface which approaches the running surface T of the support web W along the direction opposite to the running direction (a) and is upwardly convex.

Except for the above-described point, the bar coater 104 has the same structure as the bar coater 100.

In the coating liquid flow-forming flow passage B of the bar coater 104, for the same reason as mentioned for the bar coater 102, a larger dynamic pressure is generated than in the coating liquid flow-forming flow passage B of the bar coater 100, even if the speed of the coating liquid flow (f) is slow.

Therefore, in addition to the same features as the bar coater 100, the bar coater 104 has the feature of effectively preventing the accompanying air from being brought into the coating liquid reservoir A even if the amount of coating liquid being supplied from the pump P is small.

4. Fourth Embodiment

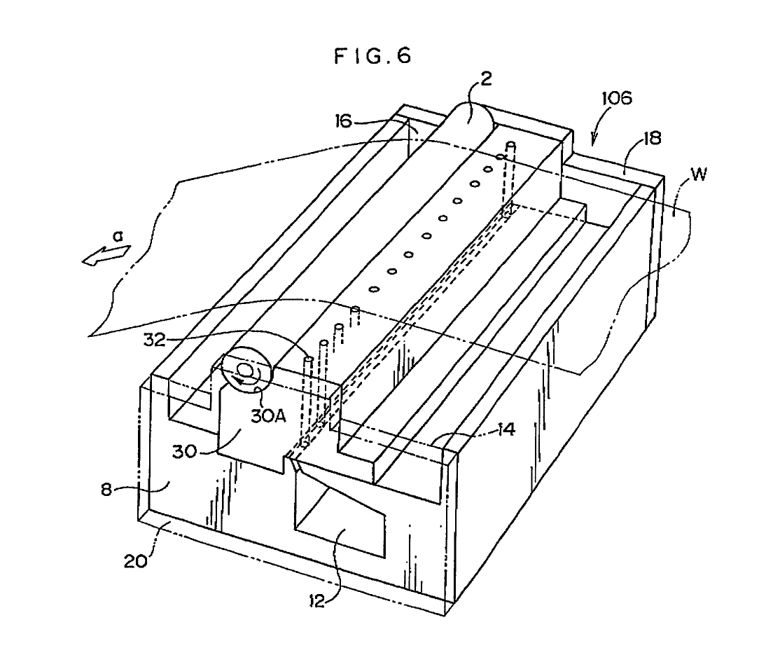

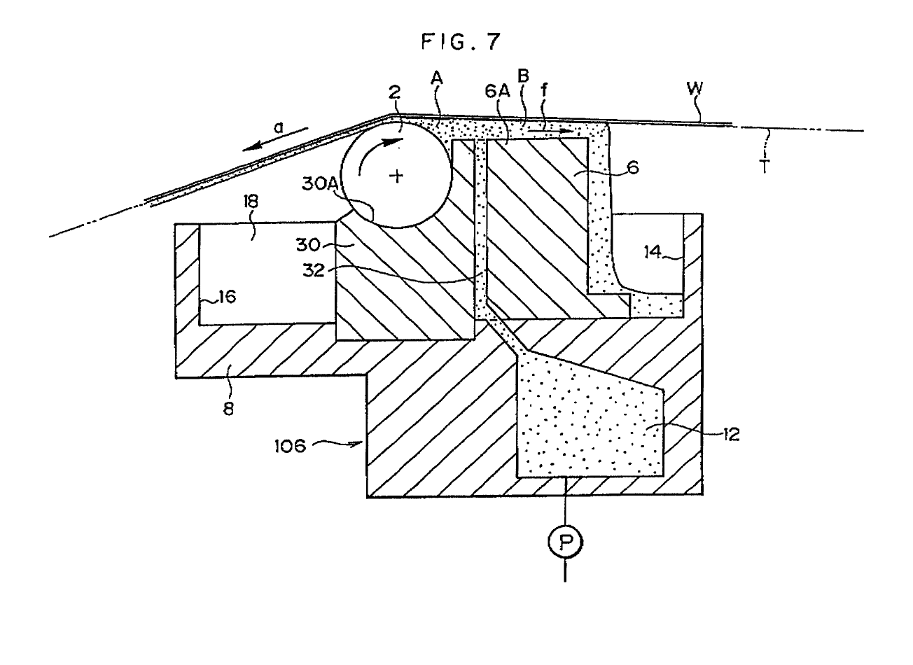

Among coating devices in accordance with the present invention, an embodiment having a coating liquid supply flow passage, in which through-holes formed in the vertical direction are arranged in a line, is shown in FIG. 6 and FIG. 7. In FIG. 6 and FIG. 7, reference characters the same as in FIG. 1 to FIG. 3 denote the same elements as the elements denoted thereby in FIG. 1 to FIG. 3, unless otherwise noted.

As shown in FIG. 6 and FIG. 7, in a bar coater 106 in accordance with a fourth embodiment, a bar support member 30 having the shape of a block shaped like a long, thick plate is disposed on the base 8 along a direction perpendicular to the running direction (a) of the support web W.

The bar support member 30 is formed with the shape of a flat plane at a top surface and, along a side on the downstream side, with a depressed groove 30A having an inside wall surface shaped like a letter J in cross section. The bar 2 is rotatably supported from the bottom side by the depressed groove 30A.

Coating liquid supply openings 32 pass through in the vertical direction on the upstream side from the depressed groove 30A of the bar support member 30. The coating liquid supply openings 32 correspond to a liquid supply passage in the coating device in accordance with the present invention. The coating liquid supply openings 32, as shown in FIG. 6, are arranged in a line at predetermined intervals along a direction of length of the bar support member 30.

It is preferable that diameters of the coating liquid supply openings 32 are 1 mm or less, particularly from 0.2 mm to 0.8 mm. The intervals of the coating liquid supply openings 32 are not particularly limited to a specific value as long as unevenness in coating of the photosensitive layer-forming liquid does not develop in the direction of width, but preferably range from 0.5 mm to 3 mm.

The coating liquid supply openings 32 communicate at bottom ends thereof with the coating liquid temporary storage chamber 12 at the bottoms.

In the bar coater 106, the bar support member 30, the coating liquid supply openings 32 and the bar 2 form the coating part in the coating device in accordance with the present invention.

Except for the above-described points, the bar coater 106 has the same configuration as the coating device in accordance with the first embodiment.

When the coating liquid is discharged from the coating liquid supply openings 32 in the bar coater 106 while the support web W is running, most of the coating liquid is supplied to the coating liquid reservoir A, which is surrounded by the top surface of the bar support 30 downstream from the coating liquid supply openings 32, the bottom surface of the support web W and the upstream side of the outer peripheral surface of the bar 2, and the coating liquid is applied to the bottom surface of the support web W.

Meanwhile, the remainder of the coating liquid flows into the coating liquid flow-forming flow passage B formed by the top surface of the bar support member 30 at the upstream side from the coating liquid supply openings 32 and the bottom surface of the support web W, forms the coating liquid flow (f) toward the upstream side along the direction opposite to the running direction (a), and then flows down from an upstream side edge of the top surface.

The accompanying air film generated on the surface of the support web W is pushed back to the upstream side by the coating liquid flow (f) in the coating liquid flow-forming flow passage B and thus the accompanying air film effectively prevents accompanying air from being brought into the coating liquid reservoir A.

Therefore, as is the case with the bar coater 100, the bar coater 106 can also perform stable coating even when the running speed of the support web W is high.

The bar support member 30 is a member in which the bar support member 4 is integrated with the dam plate 6 of the bar coater 100 of the first embodiment. Therefore, in addition to the features of the bar coater 100, the bar coater 106 has the features of being structured by a small number of parts and of eliminating any need for adjusting the gap between the bar support member 4 and the dam plate 6.

5. Fifth Embodiment

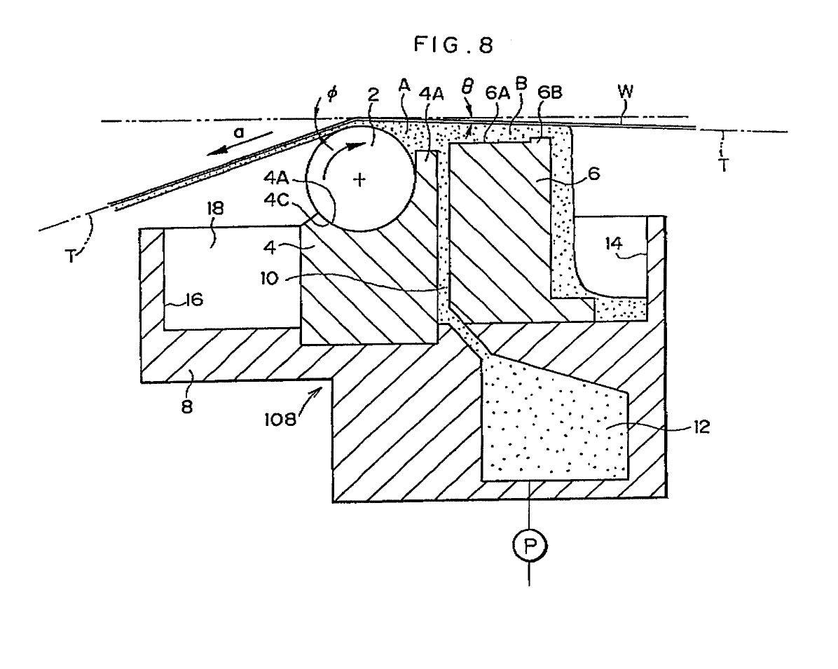

An example in which a projection continuously extending along the direction of length is provided at an upstream side end of the coating liquid flow-forming surface 6A of the dam plate 6 in the bar coater 100 of the first embodiment is shown in FIG. 8. In FIG. 8, reference characters the same as in FIG. 1 to FIG. 3 designate the same elements as the elements designated thereby in FIG. 1 to FIG. 3, unless otherwise noted.

As shown in FIG. 8, in a bar coater 108 in accordance with a fifth embodiment, a projection 6B is provided at the upstream side end of the coating liquid flow-forming surface 6A of the dam plate 6.

The projection 6B extends in the direction of length of the dam plate 6, in other words, in the direction perpendicular to the running direction (a), and has a rectangular cross section. However, the cross section of the projection 6B is not limited to a rectangle, but may be formed in various shapes such as a semi-circle, a trapezoid, a triangle or the like.

Except for the above point, the bar coater 108 has the same configuration as the bar coater 100.

Operation of the bar coater 108 is described in the following.

Since the cross-sectional area of the coating liquid flow-forming flow passage B is narrowed at the projection 6B, the coating liquid flow advancing toward the upstream side in the coating liquid flow-forming flow passage B increases in speed of flow at the portion where the projection 6B is provided. Here, the dynamic pressure of the flow is proportional to the square of the speed of flow and hence a high dynamic pressure is generated at this portion.

Therefore, since the bar coater 108 produces a high effect of preventing the accompanying air film from being brought into the coating liquid reservoir even if the discharge flow of the pump P is reduced, it is possible to carry out stable coating even if the coating liquid such as the photosensitive layer-forming liquid is applied under conditions where the running speed of the support web W is increased to reduce the thickness of the coating.

6. Sixth Embodiment

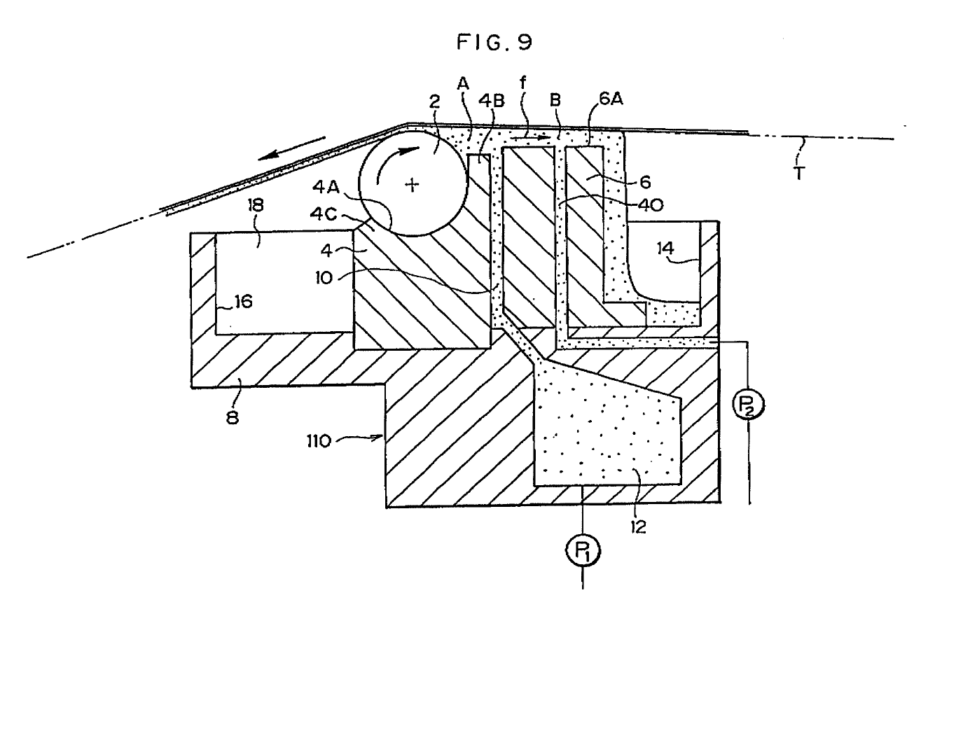

An example in which an auxiliary liquid supply passage is provided in the center of the dam plate 6 in the bar coater 100 of the first embodiment is shown in FIG. 9. In FIG. 9, reference characters the same as in FIG. 1 to FIG. 3 designate the same elements as the elements designated thereby in FIG. 1 to FIG. 3, unless otherwise noted.

As shown in FIG. 9, in a bar coater 110 in accordance with a sixth embodiment, the coating liquid temporary storage chamber 12, which communicates with the coating liquid supply flow passage 10, is connected to a coating liquid pump P₁.

A slit-like auxiliary liquid supply flow passage 40 is provided parallel to the coating liquid supply flow passage 10 in the center of the dam plate 6.

One end of the slit-like auxiliary liquid supply flow passage 40 opens at the coating liquid flow-forming surface 6A and the other end is connected to a liquid supply pump P₂ for supplying the liquid to the slit-like auxiliary liquid supply flow passage 40. The liquid may be the photosensitive layer-forming liquid or may be an affinity liquid, which has an affinity for the coating liquid, such as a solvent of the coating liquid, and which does not change the qualities of the coating liquid.

Except for the points described above, the bar coater 1 10 has the same configuration as the bar coater 100. Therefore, when the coating liquid is supplied from the coating liquid supply flow passage 10, as is the case with the bar coater 100, most of the coating liquid is supplied to a space surrounded by the support web W, the bar 2 and the bar support member 4 to form the coating liquid reservoir A, and is applied to the bottom surface of the support web W. The remainder of the coating liquid flows into the coating liquid flow-forming flow passage B and forms the coating liquid flow (f) heading for the upstream side.

When the coating liquid, for example, is supplied to the auxiliary liquid supply flow passage 40 from the second coating liquid pump P₂ in this state, the coating liquid is discharged to the coating liquid flow-forming flow passage B from the auxiliary liquid supply flow passage 40. However, the coating liquid can not advance to the downstream side because it is blocked by the coating liquid flow (f) in the coating liquid flow-forming flow passage B and thus heads toward the upstream side and forms a liquid flow, in the direction opposite to the running direction of the support web W, in the vicinity of an upstream-side outlet of the coating liquid flow-forming flow passage B. Since in this liquid flow a flow of coating liquid from the auxiliary liquid supply flow passage 40 flowing in the same direction as the coating liquid flow (f) is added to the coating flow (f), it has a speed of flow higher than the coating liquid flow (f) itself.

Therefore, in addition to the features of the bar coater 100, the bar coater 110 has a feature of being capable of effectively preventing the accompanying air film from being brought into the coating liquid reservoir A because a liquid flow having a high speed of flow is formed in the vicinity of the upstream-side outlet of the coating liquid flow-forming flow passage B, even if the speed of flow of the coating liquid supplied from the coating liquid supply flow passage 10 is low.

Further, the bar coater 110 has a feature of enabling control of the speed of liquid flow in the vicinity of the upstream-side outlet of the coating liquid flow-forming flow passage B, independently of the flow rate of the coating liquid in the coating liquid supply flow passage 10, by control of the flow rate of the coating liquid or affinity liquid supplied from the auxiliary liquid supply flow passage 40.

The present invention will hereinafter be described in detail by the use of Examples. The present invention, however, is not limited to the range of the following Examples.

### EXAMPLES

### Example 1

One surface of an aluminum web 1 m in width was made rough and was then subjected to anodic oxidation to make a support web W.

A photosensitive substance, a binder, an activating agent, a dyestuff and a thickener were dissolved in an organic solvent to prepare a photosensitive layer-forming liquid. Photosensitive layer-forming liquids having a viscosity of 25 cp and a viscosity of 50 cp were prepared.

Then, the photosensitive layer-forming liquid was applied to the support web W by using the bar coater 100 as shown in FIG. 1 and FIG. 2 under the following conditions: the liquid was supplied to the coating liquid supply flow passage 10 at a feed rate of 100,000 cc/m²•sec; a tension of 100 kg/m was applied to the support web W; and the bar 2 was rotated at a speed of 5 rpm in the direction opposite to the running direction (a) of the support web W.

In the bar coater 100, the thickness of the coating liquid supply flow passage 10 was 0.5 mm, and the distance between the coating liquid flow-forming surface 6A of the dam plate 6 and the support web W was 0.5 mm. Further, the coating liquid flow-forming surface 6A was 0.5 mm higher than the top end surface of the upstream side wall 4B of the bar support member 4.

In both the cases where the photosensitive layer-forming liquid having one of the two viscosities was used, the liquid was not observed to be discontinuous until a feed speed of the support web W reached 200 m/min, and a uniform coated surface was obtained.

### Example 2

The photosensitive layer-forming liquid was applied to a support web W similar to the support web W in example 1 by the use of the bar coater 108 as shown in FIG. 8 at a liquid feed rate of 70,000 cc/m²•sec in the coating liquid supply flow passage 10.

The tension applied to the support web W, the rotational direction and speed of the bar 2, the thickness of the coating liquid supply flow passage 10, the distance between the coating liquid flow-forming surface 6A of the dam plate 6 and the support web W, and the difference in height between the coating liquid flow-forming surface 6A and the top end surface of the upstream side wall 4B in the bar support member 4 were the same as in Example 1. Further, as the photosensitive layer-forming liquid, of the two used in Example 1, the one having a viscosity of 25 cp was used.

The liquid was not observed to be discontinuous until the feed speed of the support web W reached 200 m/min, and a uniform coated surface was obtained.

### Comparative Example 1

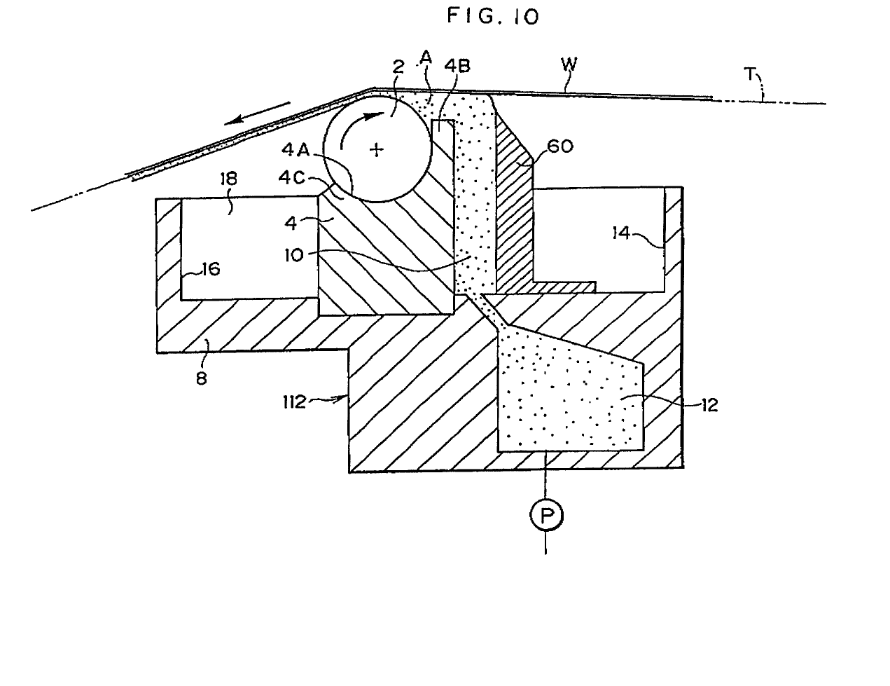

By using an HSB type bar coater as shown in FIG. 10 in place of the coating device in accordance with the present invention, a photosensitive layer-forming liquid similar to that of Example 1 was applied to the support web W similarly to Example 1.

As shown in FIG. 10, an HSB type bar coater 112 has a configuration having a first dam plate 60 in place of the dam plate 6 of the bar coater 100 of the first embodiment. The first dam plate 60 is different from the darn plate 6 provided on the bar coater in accordance with the embodiments 1 to 5 in that a top end portion is formed such that thickness of a flow path is reduced toward the downstream side.

Except for the above point, the configuration of the HSB type bar coater 112 is the same as that of the bar coater 100.

In the HSB type bar coater 112, the thickness of the coating liquid supply flow passage 10 was 0.8 mm and the distance between the first dam plate 60 and the support web W was 0.5 mm. Further, the first dam plate 60 was 0.5 mm higher than the top end surface of the upstream side wall 4B of the bar support member 4.

A tension of the same magnitude as was applied in Example 1 was applied to the support web W, and the same photosensitive layer-forming liquids as were used in Example 1 were used.

In the case where the photosensitive layer-forming liquid having a viscosity of 25 cp was used, the liquid was not observed to be discontinuous on the coated surface until the running speed of the support web W reached 120 m/min, but discontinuous liquid coating occurred at running speeds above 120 m/Min. Further, discontinuous liquid coating also occurred when the photosensitive layer-forming liquid having a viscosity of 50 was used.

### Comparative Example 2

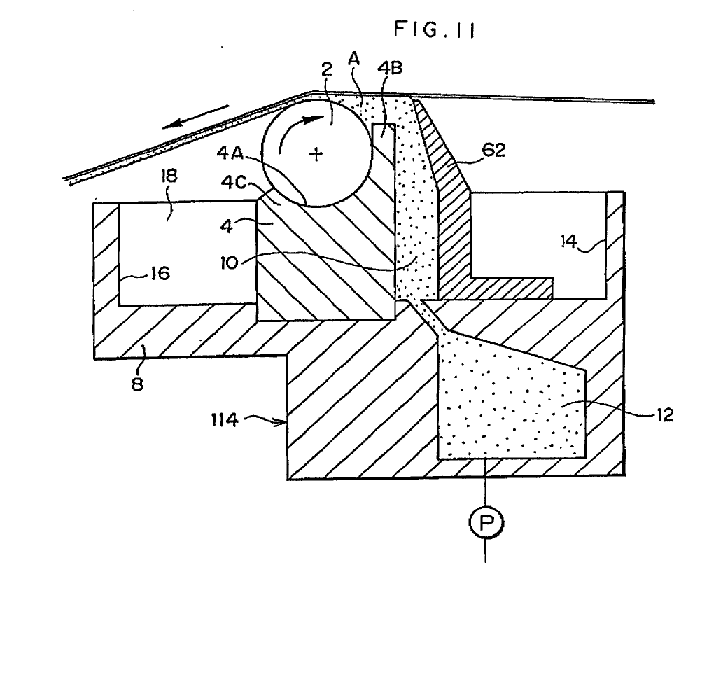

In place of the coating device in accordance with the present invention, an SLB type bar coater as disclosed in Japanese Utility Model Application No. 63-126232 was used, aid the same support web W and photosensitive layer-forming liquid as were used in Example 1 were used. The configuration of the SLB type bar coater is shown in FIG. 11.

As shown in FIG. 11, in an SLB type bar coater 114, a top end portion of a first dam plate 62 positioned at an upstream side from the bar 2 and the bar support member 4 is bent toward the bar 2 and a flat surface of 0.1 mm to 1 mm in length is formed on the top portion.

In this Comparative Example, the thickness of the coating liquid supply flow passage 10 was 5.0 mm and a distance between the first dam plate 62 and the support web W was 0.5 mm. Further, the first dam plate 62 was 0.5 mm higher than the top end surface of the upstream side wall 4B of the bar support member 4. Except for the above points, the configuration of this bar coater was the same as the bar coater 100. Further, the tension applied to the support web W and the running speed of the support web W were the same as those in Example 1.

Coating could be carried out until the running speed of the support web W reached 60 m/min, but discontinuous coating occurred when the running speed exceeded 60 m/min. Further, discontinuous coating also occurred when the photosensitive layer-forming liquid having a viscosity of 50 cp was used in place of the one having a viscosity of 25 cp.

### Comparative Example 3

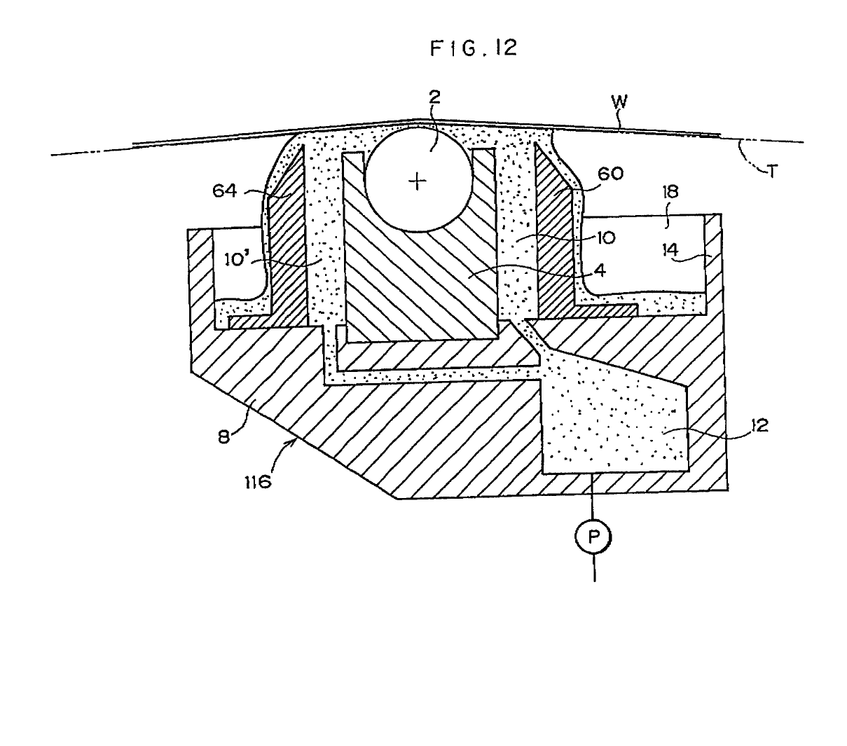

In place of the coating device in accordance with the present invention, a PBS type bar coater as disclosed in JP-B No. 58-4589 was used, and the same support web W and photosensitive layer-forming liquid as were used in Example 1 were used. The configuration of the PBS type bar coater is shown in FIG. 12.

As shown in FIG. 12, in a PBS type bar coater 116, a second dam plate 64 is provided at a side of the bar support member 4 opposite to the side thereof of the first dam plate 60.

The second dam plate 64 is different from the dam plate 6 provided in the bar coaters of the first to fifth embodiments in that a bottom end portion is bent toward the downstream side and a top end portion decreases thickness of a flow path toward the upstream side.

Further, between the second dam plate 64 and the bar support member 4 is provided an auxiliary liquid supply passage 10′ for supplying the coating liquid, such as the photosensitive layer-forming liquid or the like, to the support web W. The auxiliary liquid supply passage 10′ also communicates with the coating liquid temporary storage chamber 12.

In the present Comparative Example, the thicknesses of the coating liquid supply flow passage 10 and of the auxiliary liquid supply passage 10′ were each 5.0 mm. The distance between the first dam plate 60 and the support web W and the distance between the second dam plate 64 and the support web W were each 3 mm. Further, the first darn plate 60 and the second dam plate 64 were each 1 mm higher than the top end surface of the upstream side wall 4B of the bar support member 4.

The same tension as was applied in Example 1 was applied to the support web W and the photosensitive layer-forming liquid having the same composition as was used in Example 1 was used. However, with regard to viscosity, only the photosensitive layer-forming liquid having a viscosity of 25 cp was used.

When the support web W was run at a speed of 20 m/min, ripple-shaped streaks were produced on the coated surface.

As described above, the present invention can provide a coating device and a coating method by which stable coating can be carried out without producing a discontinuous coating film, even if a support web is run at a high speed.

What is claimed is:

1. A device for coating a web with coating liquid while the web is being conveyed along a path of travel, the device comprising:
a bar disposed along The path of travel and contacting the web as the web is conveyed, the bar being rotatable about an axis;
a liquid supply passage including an opening in the vicinity of the bar, upstream of the bar with respect to a conveyance direction of the web, through which coating liquid is supplied between the web and the bar to form a coating liquid reservoir, and
an air-intrusion preventing structure which causes fluid to flow along a surface of the web upstream of the coating liquid reservoir with respect to the web conveyance direction, and prevents an air film generated at the surface of the web from intruding between the bar and the web.

2. The device of claim 1, wherein the direction of fluid flow is opposite to the web conveyance direction.

3. The device of claim 1, wherein the fluid comprises the coating liquid.

4. The device of claim 3, wherein the air-intrusion preventing structure comprises at least part of walls of the liquid supply passage and a dam plate disposed upstream of the liquid supply passage with respect to the web conveyance direction.

5. The device of claim 4, wherein the dam plate comprises a top surface which includes a fluid now-forming surface, and wherein, during coating, some of the coating liquid supplied from the liquid supply passage flows between the fluid flow-forming surface and the web to form the flow of fluid toward a direction opposite to the web conveyance direction.

6. The device of claim 5, wherein the fluid flow-forming surface comprises a length along the web conveyance direction of more than 0.1 mm and at most 20 mm.

7. The device of claim 5, wherein the dam plate is spaced from 0.25 mm to 2 mm apart from the web surface.

8. The device of claim 1, wherein the opening of the liquid supply passage has a length extending along the width of the web and a width along the conveyance direction of at most 2 mm.

9. The device of claim 1, wherein the bar rotates in a direction opposite to the web conveyance direction.

10. The device of claim 1, wherein the bar rotates in a direction not opposite to the web conveyance direction.

11. The device of claim 5, wherein the fluid flow-forming surface comprises a surface that slopes towards the web surface along the direction opposite to the web conveyance direction.

12. The device of claim 11, wherein the fluid flow-forming surface comprises a substantially flat surface.

13. The device of claim 11, wherein the fluid flow-forming surface comprises a curved surface.

14. The device of claim 13, wherein the curved surface is convex in a direction facing the web.

15. The device of claim 1, wherein the liquid supply passage comprises a plurality of coating liquid supply openings extending along the width of the web.

16. The device of claim 5, wherein the fluid flow-forming surface comprises, at an upstream side portion thereof with respect to the web conveyance direction, a projection that projects towards the web.

17. The device of claim 3, wherein the air-intrusion preventing structure comprises at least part of walls of the liquid supply passage, another liquid supply passage, and a dam plate disposed upstream of the liquid supply passage with respect to the web conveyance direction.

18. The device of claim 17, further comprising a first pressure source connected to the liquid supply passage and a second pressure source connected to the another liquid supply passage.

19. A method for coating a web, the method comprising the steps of:
conveying the web while in contact with a bar;
supplying coating liquid to a coating region between the bar and the web; and
preventing an air film from intruding into the coating region by causing fluid to flow along a surface to be coated of the web.

20. The method of claim 19, further comprising the step of rotating the bar.
